(19) United States
(12) Patent Application Publication
(10) Pub. No.: US 2025/0258654 A1
(43) Pub. Date: Aug. 14, 2025

(54) RETRIEVAL AUGMENTED GENERATION BASED ON PROCESS ARTIFACTS

(71) Applicant: SAP SE, Walldorf (DE)

(72) Inventors: Qiu Shi Wang, Singapore (SG); Lin Cao, Singapore (SG)

(21) Appl. No.: 18/441,198

(22) Filed: Feb. 14, 2024

(51) Int. Cl. G06F 8/20

(52) U.S. Cl. CPC G06F 8/20

(57) ABSTRACT

A computer-implemented method may comprise obtaining a configuration of a process created via a software development platform, where the configuration of the process comprises a plurality of artifacts, generating analysis data for an artifact in the plurality of artifacts based on metadata of the artifact, and generating a page generation prompt based on the metadata of the artifact and the analysis data for the artifact, where the page generation prompt is configured to instruct a large language model to generate a page of a software application. The computer-implemented method may further comprise obtaining a metadata file for the page of the software application based on the page generation prompt using the large language model, and providing the metadata file for the page of the software application to the software development platform.

### TECHNICAL FIELD

The present application relates generally to the technical field of computer systems, and, in various embodiments, to systems and methods of using retrieval augmented generation based on process artifacts to build a software application.

### BACKGROUND

Process automation software applications provide workflow management and robotic process automation (RPA) features for inexperienced developers to develop process automation, which may contain various artifacts to automate their business workflow. However, software development for these automated processes still rely on professional developers to embed the artifacts into a software application, such as to write code to integrate artifacts into a mobile application. This step of software application development still relies on the expertise of a professional developer for code writing. As a result, current software development technologies do not effectively and efficiently enable inexperienced developers to build software applications. Other technical challenges may arise as well.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is a block diagram illustrating an example software development system.

FIG. 2 is a flowchart illustrating an example method of using retrieval augmented generation based on process artifacts to build a software application.

FIG. 3 illustrates an example graphical user interface (GUI) in which a configuration of a process created via a software development platform is displayed.

FIG. 4 illustrates an example GUI in which a metadata file for a page of a software application is rendered in a page editor of the software development platform.

FIG. 5 illustrates an example GUI in which the page of a deployed build version of the software application is displayed.

FIG. 6 is a block diagram of an example computer system on which methodologies described herein can be executed.

### DETAILED DESCRIPTION

Example methods and systems of using retrieval augmented generation based on process artifacts to build a software application are disclosed. In the following description, for purposes of explanation, numerous specific details are set forth in order to provide a thorough understanding of example embodiments. It will be evident, however, to one skilled in the art that the present embodiments can be practiced without these specific details.

The implementation of the features disclosed herein involves a non-generic, unconventional, and non-routine operation or combination of operations. By applying one or more of the solutions disclosed herein, some technical effects of the system and method of the present disclosure are to use retrieval augmented generation based on process artifacts to build a software application. In some example embodiments, a computer system may perform a computer-implemented method comprising obtaining a configuration of a process created via a software development platform, where the configuration of the process comprises a plurality of artifacts, generating analysis data for an artifact in the plurality of artifacts based on metadata of the artifact, and generating a page generation prompt based on the metadata of the artifact and the analysis data for the artifact, where the page generation prompt is configured to instruct a large language model to generate a page of a software application. The computer-implemented method may further comprise obtaining a metadata file for the page of the software application based on the page generation prompt using the large language model and providing the metadata file for the page of the software application to the software development platform.

The features of the present disclosure enable a computer system to effectively and efficiently analyze the artifacts of a process to understand its structure and logic and provide intelligent adaptive software code generation for different platforms with native user interface technology. As a result, the features of the present disclosure improve software development technology, enabling inexperienced developers to effectively and efficiently build software applications. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

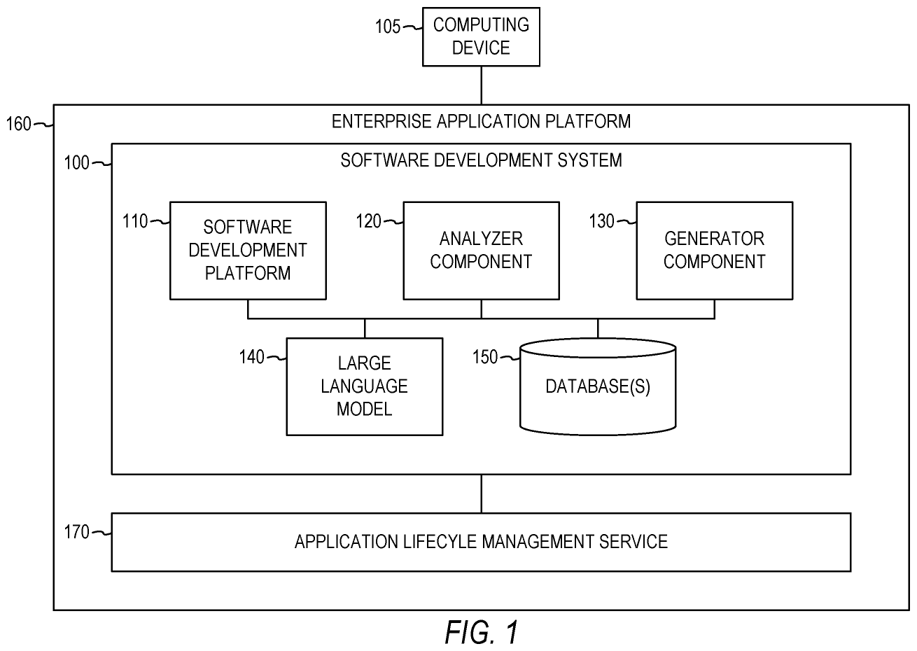

FIG. 1 is a block diagram illustrating an example software development system 100. In some example embodiments, the software development system 100 may comprise any combination of one or more of a software development platform 110, an analyzer component 120, a generator component 130, a large language model 140, or one or more databases 150. The components shown in FIG. 1 may be configured to communicate with each other via inter-process communication or via one or more network connections.

One or more of the components of the software development system 100 may be implemented as part of a cloud-based system. For example, one or more of the components of the software development system 100 may be incorporated into an enterprise application platform 160, providing server-side functionality via a network (e.g., the Internet) to a computing device 105 of a user. The enterprise application platform 160 may comprise web servers and Application Program Interface (API) servers that can be coupled to, and provide web and programmatic interfaces to, application servers. The application servers can be, in turn, coupled to one or more database servers that facilitate access to the database(s) 150. The web servers, API servers, application servers, and database servers can host cross-functional services, which may include relational database modules to provide support services for access to the database(s) 150. Additionally or alternatively, one or more of the components of the software development system 100 may be installed and run on a local on-premise network of the computing device 105 or on the computing device 105 itself.

In some example embodiments, the software development system 100 may comprise a no-code software development technology configured to generate application logic and a user interface of a mobile application, using artifacts (e.g., data type, process, action, decision, form, triggers, etc.) from a business process as inputs. The software development system 100 may use the analyzer component 120 to analyze a business process automation that has been created via the software development platform 110, retrieve its artifacts, and understand it structure and inherent logic. The software development system 100 may use the generator component 130 to generate the application logic and user interface of the mobile application.

The software development platform 110 may be configured to enable a user of the computing device 105 to create application software through graphical user interfaces and configuration, such as by using drag-and-drop tools to configure elements of a process. The process may comprise a plurality of artifacts arranged in a particular configuration. An artifact may comprise a byproduct of software development that helps describe the architecture, design, or function of software. Examples of artifacts may include, but are not limited to, data types, processes, actions, decisions, forms, and triggers. Other types of artifacts are also within the scope of the present disclosure.

The analyzer component 120 may be configured to analyze the process and its related artifacts. The analyzer component 120 may traverse the hierarchical structure of this process and generate analysis data for each artifact in the process. The analysis component 120 may generate the analysis data by using metadata to generate an analysis generation prompt, which may be used to instruct the large language model 140 to generate the analysis data for the artifact.

The analyzer component 120 may generate the analysis generation prompt using documentation for robotic process automation software. For example, the analyzer component 120 may use metadata of the artifact to query a vector database comprising a list of vector embeddings corresponding to documents for robotic process automation software. The database(s) 150 may comprise the vector database comprising the list of vector embeddings corresponding to the documentation. The database(s) 150 may also store the documentation themselves.

In some example embodiments, the analyzer component 120 may also use the metadata of each artifact to determine whether to the point in the process corresponding to the artifact is applicable for different end users to interact with via a mobile device (e.g., a mobile phone, a smart watch), and, thus, whether to proceed with generating application logic and a user interface of a mobile application. The analysis component 120 may be configured to generate the analysis data in response to, or otherwise based on, the analyzer component 120 determining that the point in the process corresponding to the artifact is applicable for different end users to interact with via a mobile device. The analysis component 120 may determine whether the point in the process corresponding to the artifact is applicable for different end users to interact with via a mobile device by using a suitability determination prompt instructing the large language model 140 to compute an evaluation score indicating a level of suitability of the artifact for mobile applications. The evaluation score may then be used to determine whether the point in the process corresponding to the artifact is applicable for different end users to interact with via a mobile device.

The analyzer component 120 may generate the suitability determination prompt using guidelines for suitability of user interface elements for mobile applications. For example, the analyzer component 120 may use metadata of the artifact to query a vector database comprising a list of vector embeddings corresponding to guidelines for suitability of user interface elements for mobile applications. The database(s) 150 may comprise the vector database comprising the list of vector embeddings corresponding to the guidelines, The database(s) 150 may also store the guidelines themselves.

The generator component 130 may be configured to generate a page generation prompt based on metadata of the artifact and the analysis data for the artifact. The page generation prompt may be configured to instruct the large language model 140 to generate a page of a software application. The generator component 130 may also be configured to obtain a metadata file for the page of the software application based on the page generation prompt using the large language model 140, such as by sending the page generation prompt to the large language model 140.

In some example embodiments, the generator component 130 may be configured to use the analysis data of the artifact to query a vector database comprising a list of vector embeddings corresponding to documents of domain knowledge for no-code development of mobile applications. The database(s) 150 may comprise the vector database comprising the list of vector embeddings corresponding to the documents of domain knowledge. The database(s) 150 may also store the documents of domain knowledge themselves. The documents of domain knowledge may comprise one or more metadata schemas of mobile applications, reference documentation for application programming interfaces, sample code, business documentation comprising information for executing business operations, or any combination thereof. Other types of documents of domain knowledge are also within the scope of the present disclosure.

The generator component 130 may also be configured to provide the metadata file for the page of the software application to the software development platform 110. The software development platform 110 may be configured to render the page on the computing device 105 based on the metadata file for the page. The page may be rendered within a page editor of the software development platform 110, thereby enabling the user of the computing device 105 to make edits to the page. The software development platform 110 may generate a build version of the software application, and then deploy the build version of the software application to an application lifecycle management service 170. The software development platform 110 may deploy the build version of the software application by publishing the build version of the software application to a cloud environment managed by the application lifecycle management service 170, such as within the enterprise application platform 160.

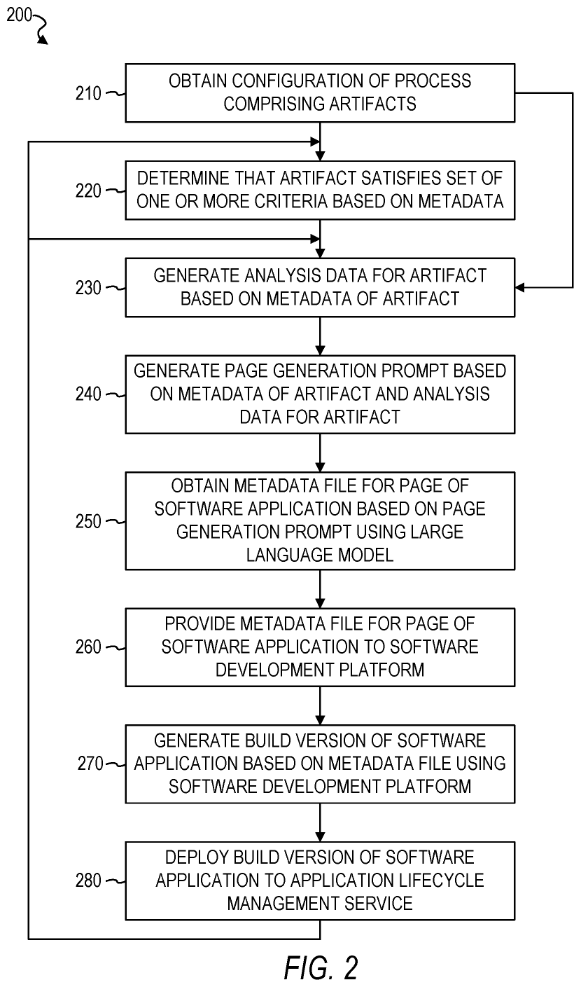

FIG. 2 is a flowchart illustrating an example method 200 of using retrieval augmented generation based on process artifacts to build a software application. The method 200 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 200 are performed by the software development system 100 of FIG. 1 or any combination of one or more of its components.

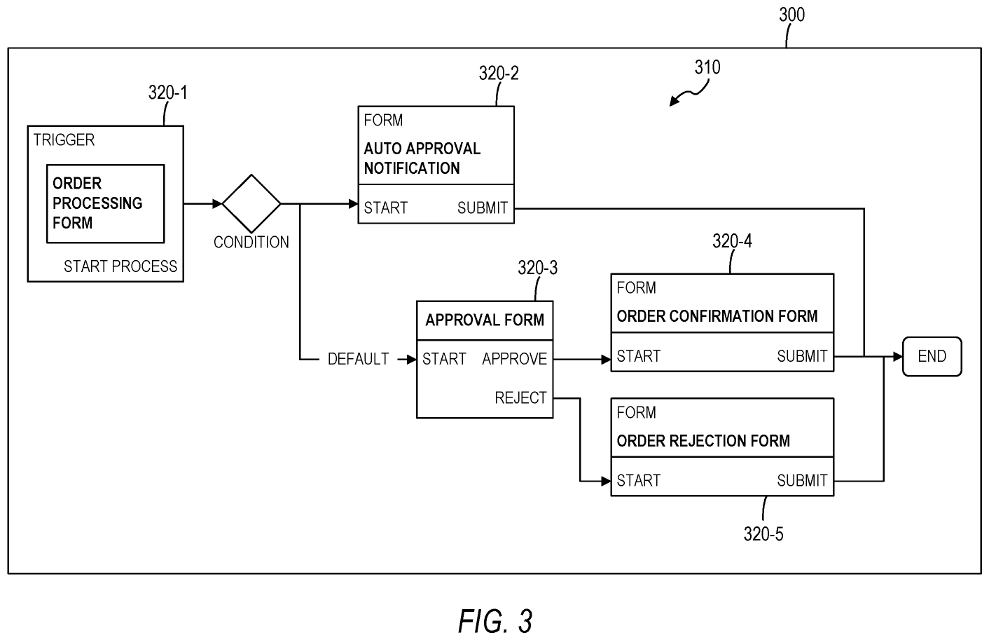

At operation 210, the analyzer component 120 may obtain a configuration of a process created via a software development platform 110. The configuration of the process may comprise a plurality of artifacts. FIG. 3 illustrates an example GUI 300 in which a configuration of a process 310 created via a software development platform 110 is displayed. In the example shown in FIG. 3, the process 310 comprises a plurality of artifacts 320-1 to 320-5 displayed within a process editor. The process 310 shown in FIG. 3 is an Order Processing process that is part of a Sales Order Approval process.

Referring back to FIG. 2, the analyzer component 120 may then, at operation 220, determine that an artifact 320 in the plurality of artifacts 320 satisfies a set of one or more criteria based on metadata of the artifact 320. Operation 220 may be part of a recursive operation that recursively determines, for each artifact 320 in the plurality of artifacts 320, whether the artifact 320 satisfies the set of one or more criteria based on the metadata of the artifact 320. The analyzer component 120 may obtain the metadata of the artifact 320 from a manifest file of the artifact 320 stored in the database(s) 150. The manifest file of the artifact 320 may be in JavaScript® Object Notation (JSON, such as shown below in an example manifest file for the artifact 320-3 that corresponds to an Approval Form:

```
{
  “uid” : “5679b0dd-447c-4323-86d0-662e10f69dfe”,
  “name” : “Approval Form”,
  “description” : “Form to approve or reject the sales order”,
  “identifier” : “approvalForm”,
  “type” : “bpi.form”,
  “visibility” : true,
  “activated” : true,
  “header” : {
    “outcomes” : [{
      “id” : “approve”,
      “name” : “Approve”
    }, {
      “id” : “reject”,
      “name” : “Reject”
    } ],
    “inputs” : {
      “$schema” : “http://json-schema.org/draft-07/schema”,
      “title” : “input”,
      “type” : “object”,
      “required” : [ “fb7X7UfAyPXs_WyYNyAgDau”,
“fbC5nFrUkQH2ByJ1CnBbDwg”, “fb5WvTv3A7of1FmxvWCtNrb”,
“fbUuAsQvHei4EEMqw8r1Epv”, “fbuaZVJIWp_MjURFbrF4nLi”,
“fbHki6eK9j0v4MGEbm2_1W1” ],
      “properties” : {
        “fb7X7UfAyPXs_WyYNyAgDau” : {
          “title” : “Customer Name”,
          “description” : “”,
          “type” : “string”
        },
        “fbC5nFrUkQH2ByJ1CnBbDwg” : {
          “title” : “Order Number”,
          “description” : “”,
          “type” : “string”
        },
        “fb5WvTv3A7of1FmxvWCtNrb” : {
          “title” : “Order Amount”,
          “description” : “”,
          “type” : “number”
        },
        “fbUuAsQvHei4EEMqw8r1Epv” : {
          “title” : “Order Date”,
          “description” : “”,
          “type” : “string”,
          “format” : “date”
        },
        “fbuaZVJIWp_MjURFbrF4nLi” : {
          “title” : “Shipping Country”,
          “description” : “”,
          “type” : “string”
        },
        “fbHki6eK9j0v4MGEbm2_1W1” : {
          “title” : “Expected Delivery Date”,
          “description” : “”,
          “type” : “string”,
          “format” : “date”
        },
        “fbax6SFXYiGuP9tGK6nSzLc” : {
          “title” : “I acknowledge that we have received your order and will process it
based on the availability”,
          “description” : “”,
          “type” : “boolean”
        },
        “fbWaw4NjE6PG8KGjOaZ_y0O” : {
          “title” : “Message to buyer:”,
          “description” : “”,
          “type” : “string”
        }
      }
    },
    “outputs” : {
      “$schema” : “http://json-schema.org/draft-07/schema”,
      “title” : “output”,
      “type” : “object”,
      “required” : [ ],
      “properties” : {
        “fbax6SFXYiGuP9tGK6nSzLc” : {
          “title” : “I acknowledge that we have received your order and will process it
based on the availability”,
          “description” : “”,
          “type” : “boolean”
        },
        “fbWaw4NjE6PG8KGjOaZ_y0O” : {
          “title” : “Message to buyer:”,
          “description” : “”,
          “type” : “string”
        }
      }
    },
    “mode” : “bpi.approval”
  },
  “buildHeader” : null,
  “validity” : true,
  “keywords” : “bpi.forms”,
  “access” : “default”,
  “contents” : [ {
    “uid” : “fd6bc5d4-c7c1-4e0a-b2f9-a6ae9ba4220c”,
    “name” : “content”,
    “mimeType” : “application/json”,
    “size” : 3391,
    “lastUpdateRelease” : “2308.05”
  }, {
    “uid” : “b781c94e-f9b0-4ac5-bf9c-3b511ac1ba2b”,
    “name” : “descriptor”,
    “mimeType” : “application/json”,
    “size” : 4143,
    “lastUpdateRelease” : “2308.05”
  } ],
  “exportRelease” : “2308.05”,
  “lastHeaderUpdateRelease” : “2205.50”,
  “submittable” : true,
  “mode” : “managed”
}
```

The determining that the artifact 320 satisfies the set of one or more criteria, at operation 220, may comprise identifying an artifact type of the artifact 320 based on the metadata of the artifact 320, and then determining that the artifact type of the artifact 320 is included in a list of artifact types. The list of artifact types may comprise a decision, a form, and a trigger. However, the list of artifact types may comprise other artifact types as well.

Additionally or alternatively, the determining that the artifact satisfies the set of one or more criteria, at operation 220, may comprise using an evaluation score indicating a level of suitability of the artifact 320 for mobile applications. For example, the analyzer component 120 may obtain key-value pairs for a plurality of user interface properties of the artifact 320 based on the metadata. Next, the analyzer component 120 may obtain a list of vector embeddings corresponding to guidelines for suitability of user interface elements for mobile applications based on a querying of a vector database using the key-value pairs. The analyzer component 120 may then generate a suitability determination prompt based on the key-value pairs for the plurality of user interface properties of the artifact 320 and the list of vector embeddings corresponding to the guidelines for suitability. The suitability determination prompt may be configured to instruct the large language model 140 to compute an evaluation score indicating a level of suitability of the artifact 320 for mobile applications using the key-value pairs and the list of vector embeddings. The analyzer component 120 may obtain the evaluation score based on the suitability determination prompt using the large language model 140 (e.g., by sending the suitability determination prompt to the large language model 140), and then determine that the evaluation score satisfies a suitability threshold value.

Next, the analyzer component 120 may generate analysis data for the artifact 320 based on metadata of the artifact 320, at operation 230. The analysis data may comprise any combination of one or more of an analysis of a structure of the artifact 320, an analysis of input and output parameters of the artifact 320, or an analysis of a business logic of the artifact 320. Other types of analysis data for the artifact 320 are also within the scope of the present disclosure.

In some example embodiments in which the analysis data comprises an analysis of a structure of the artifact 320, the generating of the analysis data may comprise obtaining key-value pairs from a manifest file of the artifact 320, obtaining a list of vector embeddings from a vector database of vector embeddings corresponding to documentation for robotic process automation software based on a querying of the vector database using the key-value pairs, and generating an analysis generation prompt based on the manifest file of the artifact 320 and the list of vector embeddings, where the analysis generation prompt is configured to instruct the large language model 140 to generate the analysis of the structure of the artifact 320 using the manifest file of the artifact 320 and the list of vector embeddings. The analyzer component 120 may then obtain the analysis of the structure of the artifact 320 based on the analysis generation prompt using the large language model 140, such as by sending the analysis generation prompt to the large language model 140.

In some example embodiments in which the analysis data comprises an analysis of input and output parameters of the artifact 320, the generating of the analysis data may comprise obtaining key-value pairs for the input and output parameters of the artifact 320 from a manifest file of the artifact 320, obtaining a list of vector embeddings from a vector database of vector embeddings corresponding to documentation for robotic process automation software based on a querying of the vector database using the key-value pairs of the input and output parameters of the artifact 320, and generating an analysis generation prompt based on the manifest file of the artifact 320 and the list of vector embeddings, where the analysis generation prompt is configured to instruct the large language model 140 to generate the analysis of the input and output parameters of the artifact 320 using the manifest file of the artifact 320 and the list of vector embeddings. The analyzer component 120 may then obtain the analysis of the input and output parameters of the artifact 320 based on the analysis generation prompt using the large language model 140, such as by sending the analysis generation prompt to the large language model 140.

In some example embodiments in which the analysis data may comprise an analysis of a business logic of the artifact 320, the generating of the analysis data may comprise obtaining key-value pairs from a manifest file of the artifact 320, obtaining a list of vector embeddings from a vector database of vector embeddings corresponding to documentation for robotic process automation software based on a querying of the vector database using the key-value pairs, and generating an analysis generation prompt based on the manifest file of the artifact 320 and the list of vector embeddings, where the analysis generation prompt is configured to instruct the large language model 140 to generate the analysis of the business logic of the artifact 320 using the manifest file of the artifact 320 and the list of vector embeddings. The analyzer component 120 may then obtain the analysis of the business logic of the artifact 320 based on the analysis generation prompt using the large language model 140, such as by sending the analysis generation prompt to the large language model 140.

The analysis data may comprise the analysis of the structure of the artifact 320, the analysis of input and output parameters of the artifact 320, and the analysis of the business logic of the artifact 320 merged into one file of analysis data, as shown in the example below:
{
“Overall”: “This JSON represents a detailed description of an approval form, including its structure, inputs, outputs, and other relevant information.”,
“uid”: “A unique identifier for the approval form.”,
“name”: “The name of the approval form, which is \“Approval Form\” in this case.”,
“description”: “A description of the approval form, which states that it is used to approve or reject sales orders.”,
“identifier”: “An identifier for the approval form, which is \“approvalForm\” in this case.”,
“type”: “The type of the form, which is \” bpi.form\“.”,
“visibility”: “A boolean value indicating whether the form is visible or not.”,
“activated”: “A boolean value indicating whether the form is activated or not.”,
“header”: “This field contains information about the form's header, including the possible outcomes (approve or reject) and the input and output schemas.”,
“outcomes”: [“approve”, “reject”],
“mode”: “The mode of the form, which is \“ bpi.approval\” in this case.”,
“buildHeader”: null,
“validity”: “A boolean value indicating whether the form is valid or not.”,
“keywords”: “Keywords associated with the form, which is \“ bpi.forms\” in this case.”,
“access”: “The access level for the form, which is set to \“default\”.”,
“contents”: [“content file”, “descriptor file”],
“exportRelease”: “The release version of the form.”,
“lastHeaderUpdateRelease”: “The release version when the header was last updated.”,
“submittable”: “A boolean value indicating whether the form is submittable or not.”,
“Model”: “The overall model of the business process. It has a unique ID, a class definition, a name, and other properties such as the process identifier and artifact ID.”,
“Events”: “The model contains two events—a StartEvent and an EndEvent. Each event has a unique ID and a name.”,
“Activities”: “The model contains four activities—Approval Form, Order Confirmation Form, Order Rejection Notification, and Auto Approval Notification. Each activity has a unique ID and a name.”,
“Gateways”: “The model contains one gateway named Condition. It has a unique ID and a name.”,
“inputs”: “The \“inputs\” field in the given JSON represents the input fields or variables that are required for the \“Approval Form\”. These fields are used to collect information from the user filling out the form. Here is a breakdown of the \“inputs\” field:-The \“$schema\” field specifies the JSON schema version used for validation.-The \“title\” field represents the title of the input schema.—The \“type\” field specifies the data type of the input schema.—The \“required\” field is an array that lists the names of the input fields that are required.—The \ “properties\” field contains an object that defines each input field.—Each input field is represented by a key-value pair, where the key is the field name and the value is an object representing the field properties.—The \“title\” field represents the title or label of the input field.—The \“description\” field provides additional information or instructions about the input field.—The \“type\” field specifies the data type of the input field.—The \“format\” field (if present) specifies a specific format for the input field (e.g., \“date\” format). In this case, the \“inputs\” field defines several input fields such as \“Customer Name\”, \“Order Number\”, \“Order Amount\”, \“Order Date\”, \“Shipping Country\”, \“Expected Delivery Date\”, \“I acknowledge that we have received your order and will process it based on the availability\”, and \“Message to buyer\”. Each field has a title, description, and type specified. The \“outputs\” field represents the output fields or variables that are generated as a result of the form submission. In this case, the \“outputs\” field contains two fields: \“I acknowledge that we have received your order and will process it based on the availability\” and \“Message to buyer\”. These fields have similar properties as the input fields. Overall, the \“inputs\” and \“outputs\” fields define the structure and properties of the form fields in the JSON.”,
“outputs”: “The \“outputs\” field in the given JSON represents the output properties of the \“Approval Form\”. It defines the data that will be generated as output when the form is submitted.\n\nIn this case, the \“outputs\” field contains two properties:\n\n1. \“fbax6SFXYiGuP9tGK6nSzLc\”: This property represents a boolean value that indicates whether the buyer acknowledges that the order has been received and will be processed based on availability. \n\n2.
\“fbWaw4NjE6PG8KGjOaZ_y0O\”: This property represents a string value that allows the buyer to provide a message to the seller. \n\nThese properties define the data that will be generated as output when the form is submitted.”,
“Sequence Flows”: “The model contains several sequence flows, which represent the flow of the process. Each sequence flow has a unique ID and a name, such as \“Approve\”, \“Reject\”, and \“Submit\”. The given sequence contains several elements, including sequence flows and activities. The sequence flows represent the flow of control between different activities in the process. The sourceRef and targetRef attributes of the sequence flows indicate the source and target activities connected by the flow. the analysis of the sequence using the relation of sourceRef and targetRef. The sequence flow with id \“pbtnevEtrats\” connects the activity with id \“62a5077d-da50-4872-876b-96dab07a7f79\” as the source and the activity with id \“3b4ffc44-bdab-491d-953b-9af5b2045a02\” as the target. The sequence flow with id \“pbhenKOYeq6f2TLzhpBuSeX\” connects the activity with id \“bfdb0823-da44-47b8-beeb-18cf2f186c72\” as the source and the activity with id \“3b4ffc44-bdab-491d-953b-9af5b2045a02\” as the target. This sequence flow has an outcomeId attribute set to \“approve\”. The sequence flow with id \“pbD_qYSVEfJw5ZQOVXoS107\” connects the activity with id \“bfdb0823-da44-47b8-beeb-18cf2f186c72\” as the source. This sequence flow does not have a targetRef attribute, indicating that it does not connect to any target activity. This sequence flow represents a rejection outcome. The sequence flow with id \“pb01ZAIxm9sa2ktqDRuAvK8\” connects the activity with id \“62c0cec9-7202-4326-8ce8-27b2a3e4553f\” as the source and the activity with id \“3b4ffc44-bdab-491d-953b-9af5b2045a02\” as the target. The sequence flow with id \“pbbK4ndwy7HjSfbIrvN36Md\” connects the activity with id \“form_orderRejectionNotification_1\” as the source and the activity with id \“endEvent_1\” as the target.”
}

At operation 240, the generator component 130 may then generate a page generation prompt based on the metadata of the artifact 320 and the analysis data for the artifact 320. The page generation prompt may be configured to instruct the large language model 140 to generate a page of a software application. In some example embodiments, the generating of the page generation prompt may comprise obtaining a list of vector embeddings from a vector database of vector embeddings corresponding to documents of domain knowledge for no-code development of mobile applications based on a querying of the vector database using the analysis data. The page generation prompt may be configured to instruct the large language model 140 to generate the page of the software application using the metadata of the artifact 320 and the list of vector embeddings. The documents of domain knowledge may comprise one or more metadata schemas of mobile applications, reference documentation for application programming interfaces, sample code, business documentation comprising information for executing business operations, or any combination thereof. Other types of documents of domain knowledge for no-code development of mobile applications are also within the scope of the present disclosure.

Next, the generator component 130 may, at operation 250, obtain a metadata file for the page of the software application based on the page generation prompt using the large language model 140, such as by sending the page generation prompt to the large language model 140. In some example embodiments, the metadata file may comprise a specification of one or more user interface controls. One example of the metadata file is provided below:

```
{
  “Controls”: [
    {
      “_Type”: “Control.Type.SectionedTable”,
      “_Name”: “SectionedTable0”,
      “Sections”: [
        {
          “Separators”: {
            “TopSectionSeparator”: false,
            “BottomSectionSeparator”: true,
            “HeaderSeparator”: true,
            “FooterSeparator”: true,
            “ControlSeparator”: true
          },
          “Controls”: [
            {
              “Caption”: “Description”,
              “Value”: “A new order has been received. Please review and
confirm whether the requirements can be met or not.”,
              “_Type”: “Control.Type.FormCell.Note”,
              “_Name”: “fbNiCHDxraAQiPZopfkuNqX”,
              “IsEditable”: false,
              “IsVisible”: true,
              “PlaceHolder”: “Description”
            },
            {
              “Value”: “Sales Order Details:”,
              “_Type”: “Control.Type.FormCell.Note”,
              “_Name”: “fbPTg4iaAJV6NC77etLkFy3”,
              “IsEditable”: false,
              “IsVisible”: true,
              “Separator”: true,
              “PlaceHolder”: “Description”,
              “Enabled”: true
            },
            {
              “_Type”: “Control.Type.FormCell.SimpleProperty”,
              “_Name”: “fb7X7UfAyPXs_WyYNyAgDau”,
              “IsEditable”: true,
              “IsVisible”: true,
              “Caption”: “Customer Name”,
              “PlaceHolder”: “{Customer Name}”,
              “KeyboardType”: “Number”
            },
            {
              “Value”: “{Order Number}”,
              “_Type”: “Control.Type.FormCell.SimpleProperty”,
              “_Name”: “fbC5nFrUkQH2ByJ1CnBbDwg”,
              “IsEditable”: true,
              “IsVisible”: true,
              “Caption”: “Order Number”,
              “PlaceHolder”: “Temperature”
            },
            {
              “Value”: “{Order Amount}”,
              “_Type”: “Control.Type.FormCell.SimpleProperty”,
              “_Name”: “fb5WvTv3A7of1FmxvWCtNrb”,
              “IsEditable”: true,
              “IsVisible”: true,
              “Caption”: “Order Amount”,
              “KeyboardType”: “Number”
            },
            {
              “Value”: “{Order Date}”,
              “_Type”: “Control.Type.FormCell.DatePicker”,
              “_Name”: “fbuaZVJIWp_MjURFbrF4nLi”,
              “IsEditable”: true,
              “IsVisible”: true,
              “Separator”: true,
              “Caption”: “Order Date”,
              “Mode”: “Datetime”
            },
            {
              “Value”: “{Shipping Country}”,
              “_Type”: “Control.Type.FormCell.SimpleProperty”,
              “_Name”: “fbUuAsQvHei4EEMqw8r1Epv”,
              “IsEditable”: true,
              “IsVisible”: true,
              “Caption”: “Shipping Country”,
              “PlaceHolder”: “{Shipping Country}”,
              “KeyboardType”: “Default”
            },
            {
              “Value”: “{Expected Delivery Date}”,
              “_Type”: “Control.Type.FormCell.DatePicker”,
              “_Name”: “fbHki6eK9j0v4MGEbm2_1W1”,
              “IsEditable”: true,
              “IsVisible”: true,
              “Separator”: true,
              “Caption”: “Expected Delivery Date”,
              “Mode”: “Datetime”
            },
            {
              “Value”: “Supplier Acknowledgement”,
              “_Type”: “Control.Type.FormCell.Note”,
              “_Name”: “fbnyN3upo3bAdQ4gVWUP9IX”,
              “IsEditable”: false,
              “IsVisible”: true,
              “Separator”: true,
              “PlaceHolder”: “Description”,
              “Enabled”: true
            },
            {
              “Value”: false,
              “_Type”: “Control.Type.FormCell.Switch”,
              “_Name”: “fbax6SFXYiGuP9tGK6nSzLc”,
              “IsEditable”: true,
              “IsVisible”: true,
              “Separator”: true,
              “Caption”: “I acknowledge that we have received your order and
will process it based on the availability”
            },
            {
              “Value”: “Message to buyer:”,
              “_Type”: “Control.Type.FormCell.Note”,
              “_Name”: “fbWaw4NjE6PG8KGjOaZ_y0O”,
              “IsEditable”: false,
              “IsVisible”: true,
              “Separator”: true,
              “PlaceHolder”: “Description”,
              “Enabled”: true
            },
            {
              “_Type”: “Control.Type.FormCell.Note”,
              “_Name”: “fbWaw4NjE6PG8KGjOaZ_y0O_01”,
              “IsEditable”: true,
              “IsVisible”: true,
              “Separator”: true,
              “PlaceHolder”: “PlaceHolder”,
              “Enabled”: true
            }
            ],
          “Visible”: true,
          “EmptySection”: {
            “FooterVisible”: false
          },
          “_Type”: “Section.Type.FormCell”,
          “_Name”: “SectionFormCell0”
        },
        {
          “Separators”: {
            “TopSectionSeparator”: false,
            “BottomSectionSeparator”: true,
            “HeaderSeparator”: true,
            “FooterSeparator”: true,
            “ControlSeparator”: true
          },
          “Layout”: {
            “LayoutType”: “Vertical”,
            “HorizontalAlignment”: “Leading”
          },
          “_Type”: “Section.Type.ButtonTable”,
          “_Name”: “SectionButtonTable0”,
          “Visible”: true,
          “EmptySection”: {
            “FooterVisible”: false
          },
          “Buttons”: [
            {
              “_Name”: “fbk6GoB18zwUmWm5JmZ0NzT”,
              “Title”: “Approval”,
              “Alignment”: “Center”,
              “ButtonType”: “Text”,
              “Semantic”: “Tint”,
              “ImagePosition”: “Leading”
            },
            {
              “_Name”: “fbNiBAvvklslkejvMN2L”,
              “Title”: “Reject”,
              “Alignment”: “Center”,
              “ButtonType”: “Text”,
              “Semantic”: “Tint”,
              “ImagePosition”: “Leading”
            }
          ]
        }
      ]
    }
  ],
  “_Type”: “Page”,
  “_Name”: “fbk6GoB18zwUmWm5JmZ0NzT”,
  “Caption”: “Approve Sales Order”,
  “PrefersLargeCaption”: false,
  “ActionBar”: {
    “Items”: [
      {
        “Text”: “Back”,
        “_Name”: “ActionBarItem2”,
        “Caption”: “”,
        “Icon”: “sap-icon://nav-back”,
        “Position”: “Left”,
        “IsIconCircular”: false,
        “Visible”: true
      }
    ],
    “_Name”: “ActionBar1”
  }
}
```

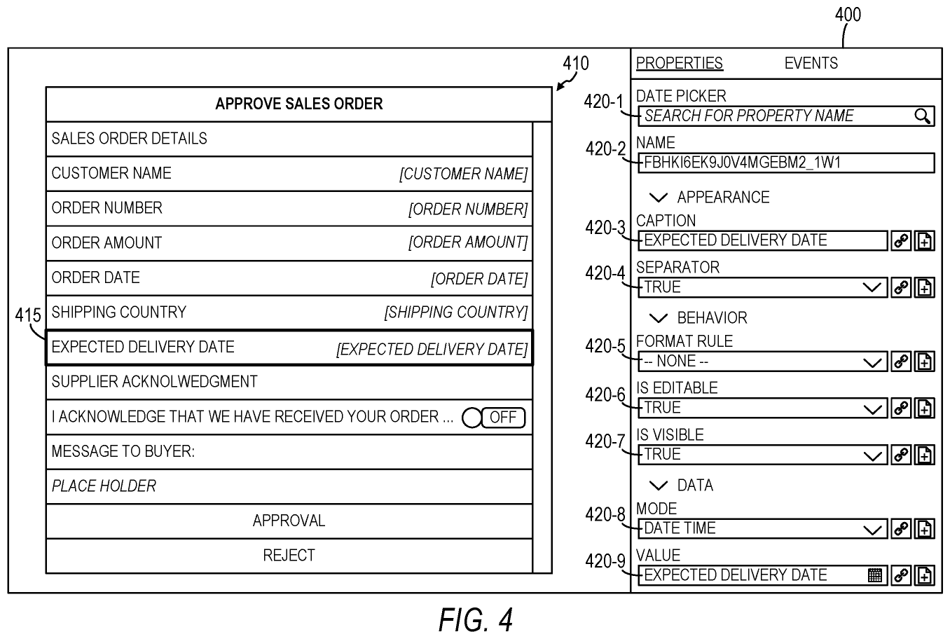

At operation 260, the generator component 130 may then provide the metadata file for the page of the software application to the software development platform 110. FIG. 4 illustrates an example GUI 400 in which a metadata file for a page of a software application is rendered in a page editor of the software development platform 110. In the GUI 400, the page 410 is displayed based on the metadata file. The page 410 may comprise user interface elements 415 of the page 410. The user may interact with the page editor of the software development platform 110 to modify aspects of the page 410. For example, the user may select one of the user interface elements 415, thereby causing a corresponding set of user interface elements 420 (e.g., 420-1 to 420-9) to be displayed in the GUI 400, such as within a side panel of the page editor. The user may interact with the user interface elements 420 to change aspects of the corresponding user interface elements 415 of the page.

Next, the software development platform 110 may, at operation 270, generate a build version of the software application based on the metadata file. For example, when the user is ready to finalize the aspects of the pages of the software application, the user may interact with the software development platform 110 to build the software application based on the metadata file and any edits made by the user.

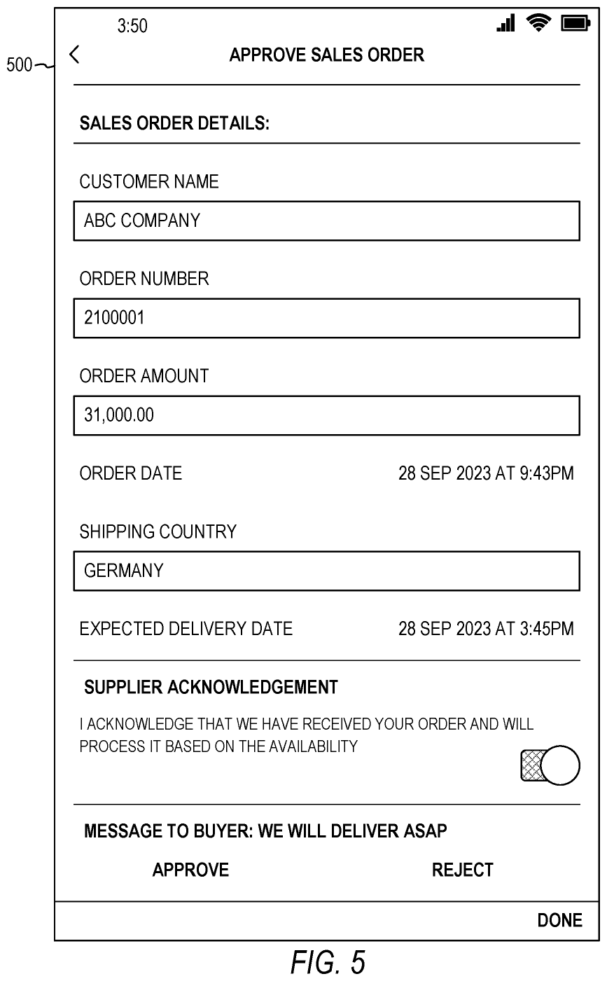

The software development platform 110 may then deploy the build version of the software application to the application lifecycle management service 170, at operation 280. As a result of this deployment, the software application may be accessed by users of computing devices 105. For example, users may access the software application on a cloud platform. Users may also download the software application onto their respective mobile devices. FIG. 5 illustrates an example GUI 500 in which the page of a deployed build version of the software application is displayed.

It is contemplated that any of the other features described within the present disclosure can be incorporated into the method 200.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: obtaining a configuration of a process created via a software development platform, the configuration of the process comprising a plurality of artifacts; generating analysis data for an artifact in the plurality of artifacts based on metadata of the artifact; generating a page generation prompt based on the metadata of the artifact and the analysis data for the artifact, the page generation prompt being configured to instruct a large language model to generate a page of a software application; obtaining a metadata file for the page of the software application based on the page generation prompt using the large language model; and providing the metadata file for the page of the software application to the software development platform.

Example 2 includes the computer-implemented method of example 1, further comprising: determining that an artifact in the plurality of artifacts satisfies a set of one or more criteria based on the metadata of the artifact, wherein the generating of the analysis data for the artifact, the generating of the prompt, and the obtaining of the metadata file are performed based on the determining that the artifact satisfies the set of one or more criteria.

Example 3 includes the computer-implemented method of example 1 or example 2, wherein the determining that the artifact satisfies the set of one or more criteria comprises: identifying an artifact type of the artifact based on the metadata of the artifact; and determining that the artifact type of the artifact is included in a list of artifact types.

Example 4 includes the computer-implemented method of any one of examples 1 to 3, wherein the list of artifact types comprises a decision, a form, and a trigger.

Example 5 includes the computer-implemented method of any one of examples 1 to 4, wherein the determining that the artifact satisfies the set of one or more criteria comprises: obtaining key-value pairs for a plurality of user interface properties of the artifact based on the metadata; obtaining a list of vector embeddings corresponding to guidelines for suitability of user interface elements for mobile applications based on a querying of a vector database using the key-value pairs; generating a suitability determination prompt based on the key-value pairs for the plurality of user interface properties of the artifact and the list of vector embeddings corresponding to the guidelines for suitability, the suitability determination prompt being configured to instruct the large language model to compute an evaluation score indicating a level of suitability of the artifact for mobile applications using the key-value pairs and the list of vector embeddings; obtaining the evaluation score based on the suitability determination prompt using the large language model; and determining that the evaluation score satisfies a suitability threshold value.

Example 6 includes the computer-implemented method of any one of examples 1 to 5, wherein the analysis data comprises an analysis of a structure of the artifact.

Example 7 includes the computer-implemented method of any one of examples 1 to 6, wherein the generating of the analysis data comprises: obtaining key-value pairs from a manifest file of the artifact; obtaining a list of vector embeddings from a vector database of vector embeddings corresponding to documentation for robotic process automation software based on a querying of the vector database using the key-value pairs; generating an analysis generation prompt based on the manifest file of the artifact and the list of vector embeddings, the analysis generation prompt being configured to instruct the large language model to generate the analysis of the structure of the artifact using the manifest file of the artifact and the list of vector embeddings; and obtaining the analysis of the structure of the artifact based on the analysis generation prompt using the large language model.

Example 8 includes the computer-implemented method of any one of examples 1 to 7, wherein the analysis data comprises an analysis of input and output parameters of the artifact.

Example 9 includes the computer-implemented method of any one of examples 1 to 8, wherein the generating of the analysis data comprises: obtaining key-value pairs for the input and output parameters of the artifact from a manifest file of the artifact; obtaining a list of vector embeddings from a vector database of vector embeddings corresponding to documentation for robotic process automation software based on a querying of the vector database using the key-value pairs of the input and output parameters of the artifact; generating an analysis generation prompt based on the manifest file of the artifact and the list of vector embeddings, the analysis generation prompt being configured to instruct the large language model to generate the analysis of the input and output parameters of the artifact using the manifest file of the artifact and the list of vector embeddings; and obtaining the analysis of the input and output parameters of the artifact based on the analysis generation prompt using the large language model.

Example 10 includes the computer-implemented method of any one of examples 1 to 9, wherein the analysis data comprises an analysis of a business logic of the artifact.

Example 11 includes the computer-implemented method of any one of examples 1 to 10, wherein the generating of the analysis data comprises: obtaining key-value pairs from a manifest file of the artifact; obtaining a list of vector embeddings from a vector database of vector embeddings corresponding to documentation for robotic process automation software based on a querying of the vector database using the key-value pairs; generating an analysis generation prompt based on the manifest file of the artifact and the list of vector embeddings, the analysis generation prompt being configured to instruct the large language model to generate the analysis of the business logic of the artifact using the manifest file of the artifact and the list of vector embeddings; and obtaining the analysis of the business logic of the artifact based on the analysis generation prompt using the large language model.

Example 12 includes the computer-implemented method of any one of examples 1 to 11, wherein the generating of the page generation prompt comprises: obtaining a list of vector embeddings from a vector database of vector embeddings corresponding to documents of domain knowledge for no-code development of mobile applications based on a querying of the vector database using the analysis data, wherein the page generation prompt is configured to instruct the large language model to generate the page of the software application using the metadata of the artifact and the list of vector embeddings.

Example 13 includes the computer-implemented method of any one of examples 1 to 12, wherein the documents of domain knowledge comprise at least one of: one or more metadata schemas of mobile applications; reference documentation for application programming interfaces; sample code; or business documentation comprising information for executing business operations.

Example 14 includes the computer-implemented method of any one of examples 1 to 13, wherein the metadata file comprises a specification of one or more user interface controls.

Example 15 includes the computer-implemented method of any one of examples 1 to 14, further comprising: generating a build version of the software application based on the metadata file using the software development platform; and deploying the build version of the software application to an application lifecycle management service.

Example 16 includes a system comprising: at least one processor; and a non-transitory computer-readable medium storing executable instructions that, when executed, cause the at least one processor to perform the method of any one of examples 1 to 15.

Example 17 includes a non-transitory machine-readable storage medium, tangibly embodying a set of instructions that, when executed by at least one processor, causes the at least one processor to perform the method of any one of examples 1 to 15.

Example 18 includes a machine-readable medium carrying a set of instructions that, when executed by at least one processor, causes the at least one processor to carry out the method of any one of examples 1 to 15.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

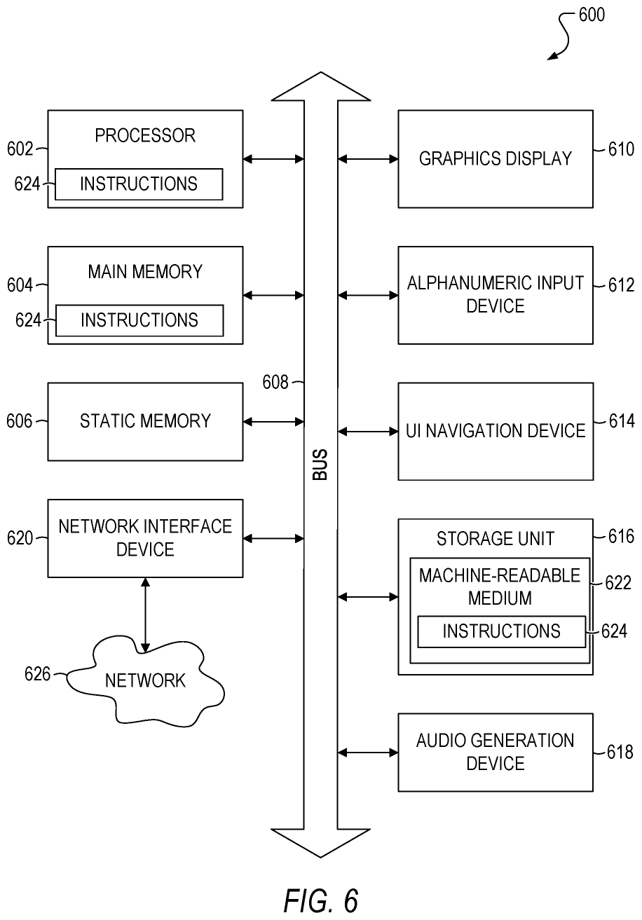

FIG. 6 is a block diagram of a machine in the example form of a computer system 600 within which instructions 624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604, and a static memory 606, which communicate with each other via a bus 608. The computer system 600 may further include a graphics or video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a storage unit (e.g., a disk drive unit) 616, an audio or signal generation device 618 (e.g., a speaker), and a network interface device 620.

The storage unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
obtaining a configuration of a process created via a software development platform, the configuration of the process comprising a plurality of artifacts;
generating analysis data for an artifact in the plurality of artifacts based on metadata of the artifact;
generating a page generation prompt based on the metadata of the artifact and the analysis data for the artifact, the page generation prompt being configured to instruct a large language model to generate a page of a software application;
obtaining a metadata file for the page of the software application based on the page generation prompt using the large language model; and
providing the metadata file for the page of the software application to the software development platform.

2. The computer-implemented method of claim 1, further comprising:
determining that an artifact in the plurality of artifacts satisfies a set of one or more criteria based on the metadata of the artifact,
wherein the generating of the analysis data for the artifact, the generating of the prompt, and the obtaining of the metadata file are performed based on the determining that the artifact satisfies the set of one or more criteria.

3. The computer-implemented method of claim 2, wherein the determining that the artifact satisfies the set of one or more criteria comprises:
identifying an artifact type of the artifact based on the metadata of the artifact; and
determining that the artifact type of the artifact is included in a list of artifact types.

4. The computer-implemented method of claim 3, wherein the list of artifact types comprises a decision, a form, and a trigger.

5. The computer-implemented method of claim 2, wherein the determining that the artifact satisfies the set of one or more criteria comprises:
obtaining key-value pairs for a plurality of user interface properties of the artifact based on the metadata;
obtaining a list of vector embeddings corresponding to guidelines for suitability of user interface elements for mobile applications based on a querying of a vector database using the key-value pairs;
generating a suitability determination prompt based on the key-value pairs for the plurality of user interface properties of the artifact and the list of vector embeddings corresponding to the guidelines for suitability, the suitability determination prompt being configured to instruct the large language model to compute an evaluation score indicating a level of suitability of the artifact for mobile applications using the key-value pairs and the list of vector embeddings;
obtaining the evaluation score based on the suitability determination prompt using the large language model; and
determining that the evaluation score satisfies a suitability threshold value.

6. The computer-implemented method of claim 1, wherein the analysis data comprises an analysis of a structure of the artifact.

7. The computer-implemented method of claim 6, wherein the generating of the analysis data comprises:
obtaining key-value pairs from a manifest file of the artifact;
obtaining a list of vector embeddings from a vector database of vector embeddings corresponding to documentation for robotic process automation software based on a querying of the vector database using the key-value pairs;
generating an analysis generation prompt based on the manifest file of the artifact and the list of vector embeddings, the analysis generation prompt being configured to instruct the large language model to generate the analysis of the structure of the artifact using the manifest file of the artifact and the list of vector embeddings; and
obtaining the analysis of the structure of the artifact based on the analysis generation prompt using the large language model.

8. The computer-implemented method of claim 1, wherein the analysis data comprises an analysis of input and output parameters of the artifact.

9. The computer-implemented method of claim 8, wherein the generating of the analysis data comprises:
obtaining key-value pairs for the input and output parameters of the artifact from a manifest file of the artifact;
obtaining a list of vector embeddings from a vector database of vector embeddings corresponding to documentation for robotic process automation software based on a querying of the vector database using the key-value pairs of the input and output parameters of the artifact;
generating an analysis generation prompt based on the manifest file of the artifact and the list of vector embeddings, the analysis generation prompt being configured to instruct the large language model to generate the analysis of the input and output parameters of the artifact using the manifest file of the artifact and the list of vector embeddings; and
obtaining the analysis of the input and output parameters of the artifact based on the analysis generation prompt using the large language model.

10. The computer-implemented method of claim 1, wherein the analysis data comprises an analysis of a business logic of the artifact.

11. The computer-implemented method of claim 10, wherein the generating of the analysis data comprises:
obtaining key-value pairs from a manifest file of the artifact;
obtaining a list of vector embeddings from a vector database of vector embeddings corresponding to documentation for robotic process automation software based on a querying of the vector database using the key-value pairs;
generating an analysis generation prompt based on the manifest file of the artifact and the list of vector embeddings, the analysis generation prompt being configured to instruct the large language model to generate the analysis of the business logic of the artifact using the manifest file of the artifact and the list of vector embeddings; and
obtaining the analysis of the business logic of the artifact based on the analysis generation prompt using the large language model.

12. The computer-implemented method of claim 1, wherein the generating of the page generation prompt comprises:
obtaining a list of vector embeddings from a vector database of vector embeddings corresponding to documents of domain knowledge for no-code development of mobile applications based on a querying of the vector database using the analysis data,
wherein the page generation prompt is configured to instruct the large language model to generate the page of the software application using the metadata of the artifact and the list of vector embeddings.

13. The computer-implemented method of claim 12, wherein the documents of domain knowledge comprise at least one of:
one or more metadata schemas of mobile applications;
reference documentation for application programming interfaces;
sample code; or
business documentation comprising information for executing business operations.

14. The computer-implemented method of claim 1, wherein the metadata file comprises a specification of one or more user interface controls.

15. The computer-implemented method of claim 1, further comprising:
generating a build version of the software application based on the metadata file using the software development platform; and
deploying the build version of the software application to an application lifecycle management service.

16. A system of comprising:
at least one hardware processor; and
a non-transitory computer-readable medium storing executable instructions that, when executed, cause the at least one hardware processor to perform computer operations comprising:
obtaining a configuration of a process created via a software development platform, the configuration of the process comprising a plurality of artifacts;
generating analysis data for an artifact in the plurality of artifacts based on metadata of the artifact;
generating a page generation prompt based on the metadata of the artifact and the analysis data for the artifact, the page generation prompt being configured to instruct a large language model to generate a page of a software application;
obtaining a metadata file for the page of the software application based on the page generation prompt using the large language model; and
providing the metadata file for the page of the software application to the software development platform.

17. The system of claim 16, wherein the computer operations further comprise:
determining that an artifact in the plurality of artifacts satisfies a set of one or more criteria based on the metadata of the artifact,
wherein the generating of the analysis data for the artifact, the generating of the prompt, and the obtaining of the metadata file are performed based on the determining that the artifact satisfies the set of one or more criteria.

18. The system of claim 17, wherein the determining that the artifact satisfies the set of one or more criteria comprises:
identifying an artifact type of the artifact based on the metadata of the artifact; and
determining that the artifact type of the artifact is included in a list of artifact types, wherein the list of artifact types comprises a decision, a form, and a trigger.

19. The system of claim 17, wherein the determining that the artifact satisfies the set of one or more criteria comprises:
obtaining key-value pairs for a plurality of user interface properties of the artifact based on the metadata;
obtaining a list of vector embeddings corresponding to guidelines for suitability of user interface elements for mobile applications based on a querying of a vector database using the key-value pairs;
generating a suitability determination prompt based on the key-value pairs for the plurality of user interface properties of the artifact and the list of vector embeddings corresponding to the guidelines for suitability, the suitability determination prompt being configured to instruct the large language model to compute an evaluation score indicating a level of suitability of the artifact for mobile applications using the key-value pairs and the list of vector embeddings;
obtaining the evaluation score based on the suitability determination prompt using the large language model; and
determining that the evaluation score satisfies a suitability threshold value.

20. A non-transitory machine-readable storage medium tangibly embodying a set of instructions that, when executed by at least one hardware processor, causes the at least one hardware processor to perform computer operations comprising:
obtaining a configuration of a process created via a software development platform, the configuration of the process comprising a plurality of artifacts;
generating analysis data for an artifact in the plurality of artifacts based on metadata of the artifact;
generating a page generation prompt based on the metadata of the artifact and the analysis data for the artifact, the page generation prompt being configured to instruct a large language model to generate a page of a software application;
obtaining a metadata file for the page of the software application based on the page generation prompt using the large language model; and
providing the metadata file for the page of the software application to the software development platform.
